(19) United States
(12) Patent Application Publication
(10) Pub. No.: US 2024/0238775 A1
(43) Pub. Date: Jul. 18, 2024

(54) METHOD AND APPARATUS FOR PURIFYING NON-AQUEOUS LIQUID, AND ION EXCHANGE RESIN PRODUCTION METHOD AND PRETREATMENT APPARATUS

(71) Applicant: ORGANO CORPORATION, Tokyo (JP)

(72) Inventors: Noriko TAKADA, Tokyo (JP); Kaoru NUKUI, Tokyo (JP)

(73) Assignee: ORGANO CORPORATION, Tokyo (JP)

(21) Appl. No.: 18/284,356

(22) PCT Filed: Feb. 17, 2022
(86) PCT No.: PCT/JP2022/006401

§ 371 Date: Sep. 27, 2023

(30) Foreign Application Priority Data
Mar. 31, 2021 (JP) 2021-061045

(51) Int. Cl. B01J 47/016; B01J 39/05; B01J 49/60

(52) U.S. Cl. CPC B01J 47/016; B01J 39/05; B01J 49/60

(57) ABSTRACT

Provided is a method for purifying a nonaqueous liquid in a simple and cost-efficient manner, without requiring a large amount of the nonaqueous liquid, by using an ion exchange resin having a reduced water content. The method for purifying a nonaqueous liquid using an ion exchange resin includes bringing the ion exchange resin into contact with a nonaqueous liquid for pretreatment having a relative permittivity at 25° C. of 20 or higher and bringing the ion exchange resin after the pretreatment into contact with a nonaqueous liquid to be purified, wherein the relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

### TECHNICAL FIELD

The present invention relates to a method and an apparatus for purifying a nonaqueous liquid using an ion exchange resin having a reduced water content and a method for producing an ion exchange resin and a pretreatment device for an ion exchange resin.

### BACKGROUND ART

In recent years, highly purified and refined nonaqueous liquids have come to be used as chemicals in the semiconductor manufacturing process and as electrolytes in lithium-ion batteries. The distillation method, in which impurities are removed by distillation, is known as a method for purifying nonaqueous liquids. However, the distillation method has technical problems, such as high facility costs, high energy requirements for the distillation process, and difficulty in performing advanced purification. Therefore, a method for purifying nonaqueous liquids by ion exchange method using ion exchange resins or ion exchange filters has been proposed. The ion-exchange method allows for highly refined removal of impurities with low facility costs and energy savings.

About 50% of the weight of an ion exchange resin is water and water eluted from the ion exchange resin during the purification of a nonaqueous liquid becomes an impurity in the nonaqueous liquid. Therefore, before the ion exchange resin is used for purifying a nonaqueous liquid, the water content in the ion exchange resin must be reduced. Known methods for reducing the water content of the ion exchange resin include decompression drying of the ion exchange resin (Patent Documents 1 to 3) and passing a nonaqueous liquid through the ion exchange resin in addition to decompression drying (Patent Document 4). Also known is a method for reducing the water content by circulating a liquid through a zeolite and an ion exchange resin (Patent Document 5).

### PRIOR-ART DOCUMENT

### Patent Document

[Patent Document 1] JP 2004-181351 A
[Patent Document 2] JP 2004-181352 A
[Patent Document 3] JP 2004-249238A
[Patent Document 4] JP 2000-505042 A
[Patent Document 5] JP 2020-121261 A

### SUMMARY OF THE INVENTION

### Technical Problems

However, the method using only decompression drying cannot sufficiently reduce the water content of the ion exchange resin. When the method for passing a nonaqueous liquid in addition to decompression drying was used, it was found that a large amount of nonaqueous liquid, several dozen to one hundred times the amount of ion exchange resin, was required. Furthermore, when decompression drying is used, strongly basic anion exchange resins with low heat resistance decompose due to heat during drying, resulting in degradation of functional groups. And in the method using zeolite, there is concern that metal ions will elute from the zeolite itself, contaminating the purified liquid.

Therefore, the present invention is to provide a method for producing an ion exchange resin and a pretreatment device for an ion exchange resin that can obtain an ion exchange resin having a reduced water content in a simple and cost-efficient manner without requiring a large amount of the nonaqueous liquid, and a method and an apparatus for purifying a nonaqueous liquid using the ion exchange resin.

### Means for Solving the Problems

In view of the above problem, the inventors have made a diligent study and found that by replacing the water in the resin with a nonaqueous liquid for pretreatment having a high affinity to water and a relative permittivity of 20 or higher, such as methanol, and then bringing the resin into contact with the nonaqueous liquid to be purified, the amount of the nonaqueous liquid used can be significantly reduced compared with the case where the nonaqueous liquid for pretreatment is not used, leading to the completion of the present invention.

That is, the present invention is a method for purifying a nonaqueous liquid using an ion exchange resin, the method comprising: a pretreatment step of bringing the ion exchange resin into contact with a nonaqueous liquid for pretreatment having a relative permittivity at 25° ° C. of 20 or higher: and a purification step of bringing the ion exchange resin after the pretreatment step into contact with a nonaqueous liquid to be purified, wherein the relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

The present invention is an apparatus for purifying a nonaqueous liquid using an ion exchange resin, the apparatus comprising: a pretreatment device provided with pretreatment means for bringing the ion exchange resin into contact with a nonaqueous liquid for pretreatment having a relative permittivity at 25° C. of 20 or higher; and a purification device provided with purification means for bringing the ion exchange resin, which has been brought into contact with the nonaqueous liquid for pretreatment, into contact with a nonaqueous liquid to be purified: wherein the relative permittivity at 25° C. of the nonaqueous liquid for pretreatment is greater than the relative permittivity at 25° ° C. of the nonaqueous liquid to be purified, and the concentration of metals to be reduced in the nonaqueous liquid for pretreatment is 5 μg/L or less.

The present invention is a pretreatment device for an ion exchange resin used for purification of a nonaqueous liquid, the device comprising: pretreatment means for bringing the ion exchange resin into contact with a nonaqueous liquid for pretreatment having a relative permittivity at 25° C. of 20 or higher, wherein the nonaqueous liquid for pretreatment is passed through the ion exchange resin at 1 BV or higher in the pretreatment means.

Furthermore, the present invention is a method for producing an ion exchange resin used for purification of a nonaqueous liquid, the method comprising: a pretreatment step of bringing the ion exchange resin into contact with a nonaqueous liquid for pretreatment having a relative permittivity at 25° C. of 20 or higher, wherein the relative permittivity at 25° ° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

### Effect of the Invention

According to the present invention, a method for producing an ion exchange resin and a pretreatment device for an ion exchange resin that can obtain an ion exchange resin having a reduced water content in a simple and cost-efficient manner without requiring a large amount of the nonaqueous liquid, and a method and an apparatus for purifying a nonaqueous liquid using the ion exchange resin.

### BRIEF DESCRIPTION OF THE DRAWINGS

FIG. 1 is a schematic diagram of a purification apparatus according to one embodiment of the present invention.

FIG. 2 is a schematic diagram of a purification apparatus according to one embodiment of the present invention.

FIG. 3 is a graph showing the results of Reference Example 1.

FIG. 4 is a graph showing the results of Reference Example 2.

FIG. 5 is a graph showing the results of Comparative Example 1 and Example 1.

FIG. 6 is a graph showing the results of Comparative Example 2 and Example 2.

### DETAILED DESCRIPTION OF THE PRESENT INVENTION

### <Method for Purifying Nonaqueous Liquid and Method for Producing Ion Exchange Resin>

The method for purifying a nonaqueous liquid according to the present invention is a method for purifying a nonaqueous liquid using an ion exchange resin, the method including: a pretreatment step of bringing the ion exchange resin into contact with a nonaqueous liquid for pretreatment having a relative permittivity at 25° ° C. of 20 or higher: and a purification step of bringing the ion exchange resin after the pretreatment step into contact with a nonaqueous liquid to be purified. In addition, the relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

The method for producing an ion exchange resin according to the present invention is a method for producing an ion exchange resin used for purification of a nonaqueous liquid and also has the above pretreatment step.

The following is a detailed description of the invention.

### [Pretreatment Step]

The pretreatment step is a step in which the ion exchange resin is brought into contact with a nonaqueous liquid for pretreatment having a relative permittivity at 25° ° C. of 20 or higher. This pretreatment step can efficiently reduce the water content in the ion exchange resin. As a result, water elution from the resin can be suppressed when the ion exchange resin is used for purification of a nonaqueous liquid to be purified. The overall amount of nonaqueous liquid used can be reduced by replacing the water in the resin with the nonaqueous liquid for pretreatment in advance using the nonaqueous liquid for pretreatment that is more compatible with water than the nonaqueous liquid to be purified. The ion exchange resin may be dried by decompression drying or other means prior to use in the pretreatment step.

### (Ion Exchange Resins)

The ion exchange resins used in the present invention may be either cation exchange resins or anion exchange resins, or may be chelating resins. Ion exchange resins are obtained, for example, by introducing functional groups into copolymers having a three-dimensional network structure, which are obtained by copolymerizing styrene and divinylbenzene (DVB) in the presence of a catalyst and a dispersing agent. The ion exchange resins may be a clear gel-type with a small pore size of the resin, or a macroreticular (MR) or macroporous (also called porous or highly-porous) type with a larger pore size of the resin.

The cation exchange resins used in the present invention include strongly acidic cation exchange resins with sulfonic acid groups and weakly acidic cation exchange resins with carboxylic acid groups. The ion form of the cation exchange resin is not limited, but the hydrogen ion form (H-form) is preferred from the viewpoint of removal of impurities such as metals. If the ion exchange resin contains a cation exchange resin, even if the nonaqueous liquid for pretreatment contains some metal impurities, they can be removed by the cation exchange resin. Therefore, the ion exchange resin preferably contains at least a cation exchange resin. Cation exchange resins include, for example, Amberlite (registered trademark) IRN99H (gel-type strongly acidic cation exchange resin, trade name, manufactured by DuPont de Nemours, Inc.), Amberjet (registered trademark) 1060H (gel-type strongly acidic cation exchange resin, trade name, manufactured by ORGANO CORPORATION), ORLITE (registered trademark) DS-1 (gel-type strongly acidic cation exchange resin, trade name, manufactured by ORGANO CORPORATION), ORLITE (registered trademark) DS-4 (microporous-type strongly acidic cation exchange resin, trade name, manufactured by ORGANO CORPORATION), Amberlite (registered trademark) IRC 76 (macroporous-type weakly acidic cation exchange resin, manufactured by DuPont de Nemours, Inc.), and Amberlite (registered trademark) FPC3500 (macroporous-type weakly acidic cation exchange resin, manufactured by DuPont de Nemours, Inc.), but are not limited to these.

The anion exchange resins used in the present invention include strongly basic anion exchange resins with quaternary ammonium bases and weakly basic anion exchange resins with primary to tertiary amino groups. The ion form of the anion exchange resin is not limited, but hydroxide ion form (OH-form), carbonic acid form or bicarbonate form are commonly used from the viewpoint of removing impurities such as metals. Examples of anion exchange resins include, for example, ORLITE (registered trademark) DS-2 (gel-type strongly basic anion exchange resin, trade name, manufactured by ORGANO CORPORATION), DS-6 (MR-type weakly basic anion exchange resin, trade name, manufactured by ORGANO CORPORATION), and Amberlite (registered trademark) IRA743 (macroporous-type boron selective resin, manufactured by DuPont de Nemours, Inc.), but are not limited to these.

The chelating resins used in the present invention are not particularly limited, but include, for example, ORLITE (registered trademark) DS-21 and DS-22 (macroporous-type chelating resins, trade names, manufactured by ORGANO CORPORATION).

The monolithic organic porous ion exchangers may be used instead of ion exchange resins. The monolithic organic porous ion exchangers are not limited as long as ion exchange groups are introduced into a monolithic organic porous material.

As the monolithic organic porous ion exchangers include, for example, a monolithic organic porous ion exchanger (hereinafter referred to as “monolithic organic porous ion exchanger of the first embodiment”) composed of a continuous skeleton phase and a continuous pore phase and in which the thickness of the continuous skeleton is 1 to 100 μm, the average diameter of the continuous pores is 1 to 1000 μm, and the total fine pore volume is 0.5 to 50 mL/g, cation exchange groups, anion exchange groups or chelating groups have been introduced, the ion exchange capacity per mass in the dry state is 1 to 6 mg equivalent/g, and the ion exchange groups are uniformly distributed in the organic porous ion exchanger.

The monolithic organic porous ion exchanger of the first embodiment include a monolithic organic porous ion exchanger which is a continuous macropore structural body in which air-bubble like macropores are overlapped with each other, and this overlapped portion becomes an opening having an average diameter of 30 to 300 μm, the total fine pore volume is 0.5 to 10 mL/g, cation exchange groups or anion exchange groups are introduced, the ion exchange capacity per mass in the dry state is 1 to 6 mg equivalent/g, the ion exchange groups are uniformly distributed in the organic porous ion exchanger, and a skeleton portion area appearing on a section in an SEM image on the sectional surface of the continuous macropore structural body (dry body) is 25 to 50% in the image region.

Moreover, the monolithic organic porous ion exchangers of the first embodiment include a monolithic organic porous ion exchanger which is a bicontinuous structural body composed of a three-dimensionally continuous skeleton having an average thickness of 1 to 60 μm made of aromatic vinyl polymer containing 0.1 to 5.0 mol % of cross-linked structure unit in all the constituent units into which the ion exchange group is introduced and a three-dimensionally continuous pore having an average diameter of 10 to 200 μm between the skeletons, the total fine pore volume is 0.5 to 10 mL/g, cation exchange groups or anion exchange groups are introduced, the ion exchange capacity per mass in the dry state is 1 to 6 mg equivalent/g, and the ion exchange group is uniformly distributed in the organic porous ion exchanger.

Here, it is generally known that the removal performance of impurities in various ion exchange resins is higher for strongly acidic resins than for weakly acidic ones and for strongly basic resins than for weakly basic ones. In the course of our investigations, the inventors confirmed that, in performing solvent replacement of water contained in various resins, strongly acidic cation exchange resins require more solvent than weakly acidic cation exchange resins or chelating resins, and strongly basic anion exchange resins require more solvent than weakly basic anion exchange resins, in other words, it was confirmed that the water in the resin was difficult to be replaced by solvent. However, it has become clear that the pretreatment step of the present invention can significantly reduce the amount of solvent required, even when using such strongly acidic cation exchange resins or strongly basic anion exchange resins, which are difficult to be replaced with solvents. Thus, the purification method according to the present invention is effective for weakly acidic cation exchange resins, chelating resins, and weakly basic anion exchange resins, of course, but the above effects are more effective when strongly acidic cation exchange resins and strongly basic anion exchange resins are used, in particular. In other words, the effect of the present invention is more effective when the ion exchange resin contains at least one of a strongly acidic cation exchange resin and a strongly basic anion exchange resin. Of course, other resins such as weakly acidic cation exchange resins, weakly basic anion exchange resins, or chelating resins may be combined with strongly acidic cation exchange resins or strongly basic anion exchange resins. As mentioned above, although strongly basic anion exchange resins are known to have low heat resistance, the present invention does not require drying of the resin, and thus also solves the problem of degradation of functional groups when strongly basic anion exchange resins are used.

In addition, for solvent replacement of water contained in the resin, the solvent must fill the inside of the resin at the same time the water leaves the inside of the resin. Therefore, larger pores in the resin are advantageous for solvent replacement. Since the pore size is larger in MR-type, porous-type, or highly-porous-type than in gel-type, MR-type, porous-type, and highly-porous-type resins are more advantageous for solvent replacement than gel-type resins. On the other hand, highly cross-linked resins have smaller pores, so highly cross-linked gel-type resins are the least likely to be replaced by solvent. However, it has become clear that the pretreatment step of the present invention can significantly reduce the amount of solvent required, even when using such a highly cross-linked gel-type strongly acidic cation exchange resin that is difficult to be replaced by solvent. In other words, the purification method of the present invention can further demonstrate the above effect when a highly cross-linked gel-type strongly acidic cation exchange resin is used, especially among strongly acidic cation exchange resins. Of course, other resins such as weakly acidic cation exchange resins, weakly basic anion exchange resins, and chelating resins can be combined with highly cross-linked gel-type strongly acidic cation exchange resins. A highly cross-linked gel-type strongly acidic cation exchange resin is specifically a gel-type strongly acidic cation exchange resin having a degree of cross-linking of 16% to 24%.

From the viewpoint of preventing contamination of the nonaqueous liquid to be purified with metal impurities, it is preferable to use ion exchange resins that have been previously reduced in the amount of metal impurities contained prior to the pretreatment step. Known methods can be used to reduce the amount of metal impurities contained in the ion exchange resin. For example, the ion form of the cation exchange resin can be changed to the H-form by using mineral acids such as hydrochloric acid and sulfuric acid. This method can reduce the amount of metal impurities in the resin while simultaneously converting the ion-exchange groups. If a commercially available ion exchange resin (e.g., ORLITE (registered trademark) DS series, manufactured by ORGANO

CORPORATION) is used, in which the amount of metal impurities contained has been reduced in advance, the pretreatment step can be performed on the ion exchange resin as is.

### (Nonaqueous Liquid for Pretreatment)

As a nonaqueous liquid for pretreatment, use one with a relative permittivity at 25° C. of 20 or higher. The relative permittivity of the nonaqueous liquid for pretreatment at 25° C. is preferably 25 or higher. As a nonaqueous liquid for pretreatment, use a nonaqueous liquid whose relative permittivity at 25° C. is greater than that of the nonaqueous liquid to be purified. Specifically, nonaqueous liquids for pretreatment include alcohols such as methanol and ethanol, glycols such as ethylene glycol and propylene glycol, and acetonitrile.

The water concentration in the nonaqueous liquid for pretreatment is preferably 100 ppm or less, and more preferably 60 ppm or less. If the water concentration in the nonaqueous liquid for pretreatment is 100 ppm or less, water contamination of the resin by the nonaqueous liquid for pretreatment in the pretreatment step can be prevented. Nonaqueous liquids for pretreatment having a water concentration of 100 ppm or less include, for example, nonaqueous liquids for pretreatment of electronics industry (EL) grade. The water concentration (ppm) is measured by the Karl Fischer method using, for example, a Karl Fischer capacitance method water content meter (trade name: Aquacounter AQ-2200, manufactured by HIRANUMA Co., Ltd.). The ppm represents the mass ratio of water to the target nonaqueous liquid. From the viewpoint of ease of availability of electronic industrial grade, alcohol having a water concentration of 100 ppm or less is preferred as a nonaqueous liquid for pretreatment, and methanol having a water concentration of 100 ppm or less is especially preferred.

In addition, the concentration of metals to be reduced in the nonaqueous liquid for pretreatment is 5 μg/L or less. In other words, in the present invention, the metal impurities to be reduced in the nonaqueous liquid for pretreatment do not affect the nonaqueous liquid to be purified. For example, if the concentration of metals to be reduced in the nonaqueous liquid for pretreatment is as high as 10 μg/L, the H-form exchange groups of the ion exchange resin are consumed in the pretreatment step to remove the metals from the nonaqueous liquid for pretreatment. Because nonaqueous liquids are less diffusive to the inside of the ion exchange resin, the flow rate must be lower than in water to achieve the metal removal performance of the ion exchange resin. Hence, metal impurities derived from the nonaqueous liquid for pretreatment are likely to remain in the resin and piping, which may affect the subsequent purification of the nonaqueous liquid. Therefore, the concentration of metals to be reduced in the nonaqueous liquid for pretreatment should be 5 μg/L or less in order not to reduce the amount of functional groups of the ion exchange resin effective in the purification of the nonaqueous liquid to be purified, and to reduce metal contamination and its effect on the purification by the nonaqueous liquid for pretreatment.

Major metals in the nonaqueous liquid for pretreatment and the nonaqueous liquid to be purified include Ag, Al, Ba, Ca, Cd, Co, Cr, Cu, Fe, K, Li, Mg, Mn, Na, Ni, Pb, Sr, Zn, and so on. Among these, metals to be reduced include Na, K, Ca, Fe, and Al. In the present specification, the concentration of metals to be reduced means the concentration of the sum of the concentrations of each of these metals to be reduced. Although metal impurities in the nonaqueous liquid for pretreatment can also be removed by contact with the ion exchange resin that performs solvent replacement if they are only a few μg/L, the amount of metals contained should be small. The concentration of metals to be reduced in the nonaqueous liquid for pretreatment can be, for example, 0.005 to 5 μg/L, preferably 2 μg/L or less. The concentration of metals to be reduced in the nonaqueous liquid to be purified before purification can be, for example, 0.01 to 100 μg/L. The metal concentration in the nonaqueous liquid can be measured, for example, using an Agilent 8900 triple quadrupole ICP-MS (trade name, manufactured by Agilent Technologies, Ltd.).

Commercially available reagents such as those exemplified above may be used as nonaqueous liquids for pretreatment. Before use as a nonaqueous liquid for pretreatment, the concentration of metals to be reduced may be reduced to 5 μg/L or less by an ion exchange resin or ion adsorption membrane with a reduced water content, if necessary.

The method of bringing the ion exchange resin into contact with the nonaqueous liquid for pretreatment is not particularly limited, but includes batch treatment methods and continuous flow-through treatment methods using columns. Of these, the continuous flow-through treatment method is preferred from the viewpoint of operability and efficiency.

In the continuous flow-through treatment method, ion exchange resins are filled in a purification column such as column. The resin-filled layer height of the purification column is not limited, and can be, for example, 300 mm or higher, preferably 600 to 1500 mm. In the examples described below, the resin-filled layer height of the purification column is not limited to this because the purification is performed on a small scale for simplicity. The nonaqueous liquid for pretreatment is then passed through at, for example, an SV (Space Velocity, h⁻¹) of 0.5 to 50, for example, 1 BV or more, preferably 1 to 20 BV, more preferably 2 to 15 BV. Here, the BV (Bed Volume) is the flow rate multiple of the nonaqueous liquid to be passed with respect to the resin volume. The direction of flow may be either downward or upward. By passing the liquid through the ion exchange resin in this manner, the water contained in the ion exchange resin is sequentially replaced by the nonaqueous liquid for pretreatment and removed.

Next, the batch treatment method is described. First, the ion exchange resin is filled in a reaction tank equipped with a stirrer. Next, the reaction tank is filled with the nonaqueous liquid for pretreatment. The volume ratio is not limited, but 2 to 200 volumes of nonaqueous liquid are suitable for 1 volume of resin. After that, leaving the resin to stand for 0.1 to 16 hours, for example, is suitable in terms of acclimating the resin to the nonaqueous liquid. After leaving the resin to stand, the stirrer is activated to mix the resin and nonaqueous liquid uniformly. The stirring speed and stirring time should be determined according to the size of the reaction tank, the treatment volume, and so on. After stirring is completed, the resin and the nonaqueous liquid for pretreatment are separated by filtration or other means to obtain a resin from which water has been removed.

The ion exchange resin that has undergone the pretreatment step can be stored immersed in the nonaqueous liquid for pretreatment used in the pretreatment step until it is used in the purification of the nonaqueous liquid to be purified. In such cases, the resin and the nonaqueous liquid for pretreatment can be separated when it is actually used for purification of the nonaqueous liquid to be purified.

### [Purification Step]

The purification step is a step in which the ion exchange resin having a reduced water content after the above pretreatment step is brought into contact with a nonaqueous liquid to be purified.

### (Nonaqueous Liquids to be Purified)

Nonaqueous liquids to be purified are, for example, chemicals and solvents used in the electronics industry. The nonaqueous liquid to be purified has a smaller relative permittivity (25° C.) than the nonaqueous liquid for pretreatment. Examples of nonaqueous liquids to be purified include propylene glycol 1-monomethyl ether 2-acetate (PGMEA), propylene glycol monomethyl ether (PGME), isopropyl alcohol (IPA), and so on. They may be used singly or in combination of two or more species. Various additives and other chemical liquids dissolved in these chemicals and solvents can also be used. Among these, the purification method according to the present invention is preferably used for the purification of any of the following selected from PGME, PGMEA, mixtures of PGME and PGMEA, and IPA, in particular, PGMEA and IPA.

The method of bringing the ion exchange resin after the pretreatment step into contact with the nonaqueous liquid to be purified is the same as the method of bringing the ion exchange resin into contact with the nonaqueous liquid for pretreatment described above. The resin-filled layer height of the purification column and the amount of nonaqueous liquid to resin volume (flow rate multiple) are as above, but can be adjusted as needed.

When the nonaqueous liquid to be purified is brought into contact with the ion exchange resin for actual purification, the nonaqueous liquid for pretreatment may be replaced with the nonaqueous liquid to be purified as necessary. In such cases, the nonaqueous liquid for pretreatment can be replaced with the nonaqueous liquid to be purified by passing typically 1 to 20 BV of the nonaqueous liquid to be purified. Since the nonaqueous liquid for pretreatment and the nonaqueous liquid to be purified mix easily, it is expected that most of the nonaqueous liquid for pretreatment will be pushed out and removed by the solvent replacement using the nonaqueous liquid to be purified through this treatment. However, if a small amount of the remaining nonaqueous liquid for pretreatment becomes an impurity in the nonaqueous liquid to be purified, the concentration of the nonaqueous liquid for pretreatment in the nonaqueous liquid to be purified should be analyzed as appropriate, and the nonaqueous liquid to be purified should be passed through until the concentration is reduced below the target concentration.

In the present invention, when a highly cross-linked strongly acidic cation exchange resin is used as the ion exchange resin, the resin has small pores and is the most difficult to be replaced by solvent, as described above. However, once water has been removed from the interior of the resin by the pretreatment of the present invention, it is difficult for nonaqueous liquids to be purified or water to penetrate from the surface to the interior of the resin. Here, it is known that PGMEA, which is preferably used as the nonaqueous liquid to be purified in the present invention, reacts with water during purification to produce acetic acid by hydrolysis. However, it became clear that by conducting the pretreatment step according to the present invention and sufficiently lowering the water concentration in the resin, a secondary effect, which is to suppress the formation of acetic acid even during the passage of PGMEA purification using a highly cross-linked strongly acidic cation exchange resin, can be achieved.

### <Pretreatment Device for Ion Exchange Resin>

The pretreatment device for an ion exchange resin according to the present invention is a pretreatment device for an ion exchange resin used for purification of a nonaqueous liquid, the device including: pre-treatment means for bringing the ion exchange resin into contact with a nonaqueous liquid for pretreatment having a relative permittivity at 25° ° C. of 20 or higher. The details of the pretreatment means are the same as those described above for the pretreatment step, and as a nonaqueous liquid for pretreatment, methanol having a water concentration of preferably 100 ppm or less and more preferably 60 ppm or less is suitable. In the pretreatment means, the nonaqueous liquid for pretreatment is passed through the ion exchange resin at 1 BV or more, preferably at 1 to 20 BV, more preferably at 2 to 15 BV. The pretreatment device for an ion exchange resin according to the present invention may be used in combination with a purification device provided with purification means for bringing the ion exchange resin, which has been brought into contact with the nonaqueous liquid for pretreatment, into contact with a nonaqueous liquid to be purified, as described below. When using a combination of both, a common or different purification column filled with ion exchange resins may be used.

### <Apparatus for Purifying Nonaqueous Liquid>

The apparatus for purifying a nonaqueous liquid according to the present invention is an apparatus for purifying a nonaqueous liquid using an ion exchange resin, the apparatus including: a pretreatment device provided with pretreatment means for bringing the ion exchange resin into contact with a nonaqueous liquid for pretreatment having a relative permittivity at 25° C. of 20 or higher; and a purification device provided with purification means for bringing the ion exchange resin, which has been brought into contact with the nonaqueous liquid for pretreatment, into contact with a nonaqueous liquid to be purified. The relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less. The details of the pretreatment means and purification means are the same as those described above for the pretreatment step and purification step, respectively.

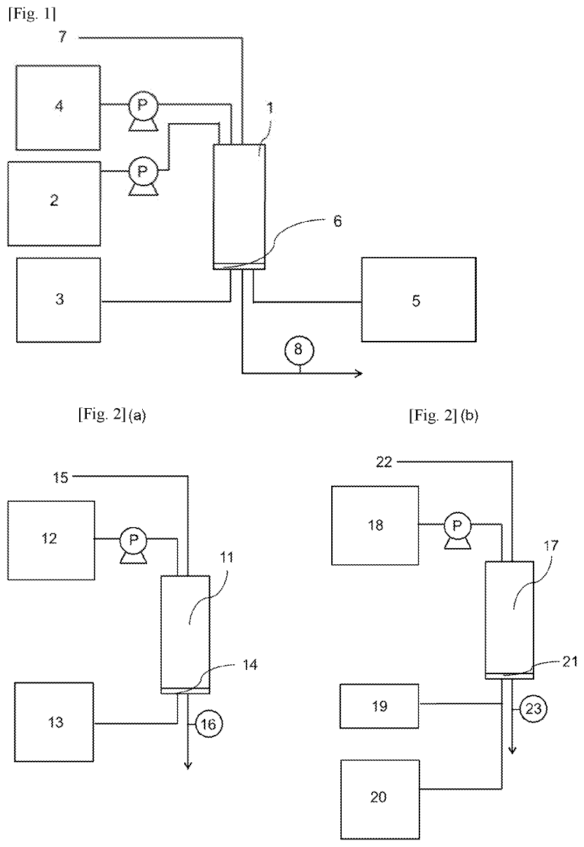

FIG. 1 is a schematic diagram of an apparatus for purifying a nonaqueous liquid according to one embodiment of the present invention. FIG. 1 shows an example of a purification apparatus having the same ion exchange resin column as a pretreatment device with pretreatment means and a purification device with purification means. First, the ion exchange resin filled in the ion exchange resin column 1 is fed with the nonaqueous liquid for pretreatment from the storage tank 2 using pump P in a downward flow. The waste liquid of the nonaqueous liquid for pretreatment, including the water contained in the ion exchange resin, is stored in storage tank 3. The nonaqueous liquid to be purified in the storage tank 4 is then passed in a downward flow from the top of the ion exchange resin column 1 using pump P for purification. The waste liquid of the mixed liquid of nonaqueous liquid to be purified and nonaqueous liquid for pretreatment in the initial stage of the flow is stored in the storage tank 3. The nonaqueous liquid to be purified after purification is collected in the storage tank 5. The mixed liquid stored in the storage tank 3 may be collected and reused after distillation, for example, or disposed of. The lower part of the ion exchange resin column 1 is equipped with eye plates and mesh 6. The ion exchange resin may be washed with acid-alkali liquid (not shown) or pure or ultrapure water (ultrapure water line 7) before pretreatment. After washing with acid-alkali liquid or other liquids, pure water washing is performed. During the pure water washing, the conductivity or resistivity value is checked with a conductivity meter or a resistivity meter 8 installed at the outlet of the ion exchange resin column 1 in order to control the acid-alkali liquid or other liquids so that they do not mix with the nonaqueous liquid for pretreatment. Pumping of the nonaqueous liquid may be done by using pumps P for each nonaqueous liquid, as shown in FIG. 1, or by using a single pump by switching it with a valve.

FIG. 2 shows an example of an apparatus for purifying a nonaqueous liquid in which (a) a pretreatment device with pretreatment means and (b) a purification device with purification means are provided separately. First, in the pretreatment device shown in FIG. 2(a), the ion exchange resin filled in the ion exchange resin column 11 is fed with the nonaqueous liquid for pretreatment from the storage tank 12 using pump P in a downward flow. The waste liquid of the nonaqueous liquid for pretreatment including the water contained in the ion exchange resin is stored in the storage tank 13. The lower part of the ion exchange resin column 11 is equipped with eye plates and mesh 14. The ion exchange resin may be washed with acid-alkali liquid (not shown) or pure or ultrapure water (ultrapure water line 15) before pretreatment. After washing with acid-alkali liquid or other liquids, pure water washing is performed. During the pure water washing, the conductivity or resistivity value is checked with a conductivity meter or a resistivity meter 16 installed at the outlet of the ion exchange resin column 11 in order to control the acid-alkali liquid or other liquids so that they do not mix with the nonaqueous liquid for pretreatment. Next, the pretreated ion exchange resin is charged into the ion exchange resin column 17 provided in the purification apparatus shown in FIG. 2(b). The nonaqueous liquid to be purified is then passed from the storage tank 18 to the ion exchange resin column 17 using pump P for purification. The waste liquid of the mixed liquid of nonaqueous liquid to be purified and nonaqueous liquid for pretreatment in the initial stage of the flow is stored in the storage tank 19. The nonaqueous liquid to be purified after purification that elutes from the outlet of the ion exchange resin column 17 is then collected in the storage tank 20. A conductivity meter or a resistivity meter 23 is installed at the outlet of the ion exchange resin column 17. The pretreatment of the ion exchange resin and the purification of the nonaqueous liquid to be purified do not necessarily have to be performed consecutively. If the pretreatment and purification of the nonaqueous liquid to be purified are not performed consecutively, the ion exchange resin after pretreatment should be stored so that it does not come in contact with water or metal impurities.

When ion exchange resins after being used for purification of nonaqueous liquid are converted to regenerated form by a regenerant such as acid or alkaline liquid and then regenerated for use, the nonaqueous liquid is first washed away and then regeneration with acid or alkaline liquid is performed. In this case, from the viewpoint of replacement efficiency, it is preferable to wash off the nonaqueous liquid by, for example, methanol, followed by washing off the methanol by a pure water. The ion exchange resin regenerated by the regenerant is reused for the purification of nonaqueous liquid by removing the regenerant with pure water, and then pretreating it again with methanol or the like.

The invention will be specifically described by means of examples below, but the invention is not limited to these examples.

### EXAMPLES

The methods for measuring the water concentration, metal concentration and acetic acid concentration are as follows.

### (Water Concentration)

Water concentration (mass ppm) in nonaqueous liquid was measured by the Karl Fischer method using a Karl Fischer capacitance method water content meter (trade name: Aquacounter AQ-2200, manufactured by HIRANUMA Co., Ltd.). The ppm represents the mass ratio of water to the target nonaqueous liquid. In the following examples, the same solvent may have different water concentrations, but this is due to lot differences.

### (Metal Concentration)

Metal concentration was measured using an Agilent 8900 triple quadrupole ICP-MS (trade name, manufactured by Agilent Technologies, Ltd.).

### (Acetic Acid Concentration)

Acetic acid concentration (mass ppm) in PGMEA was measured using a capillary electrophoresis system (trade name: Agilent 7100, Otsuka Electronics Co., Ltd.).

### <Ion Exchange Resins>

Details of each ion exchange resin used in the following examples are as follows:
AMBERLITE (registered trademark) IRN99H (trade name, manufactured by DuPont de Nemours, Inc.): gel-type strongly acidic cation exchange resin, degree of cross-linking: 16%, resin material: styrene-divinylbenzene copolymer, type of ion exchange group: sulfonic acid group
AMBERJET (registered trademark) 1060H (trade name, manufactured by ORGANO CORPORATION): gel-type strongly acidic cation exchange resin, degree of cross-linking: 16%.
ORLITE (registered trademark) DS-1 (trade name, manufactured by ORGANO CORPORATION): gel-type strongly acidic cation exchange resin, resin material: styrene-divinylbenzene copolymer, type of ion exchange group: sulfonic acid group
ORLITE (registered trademark) DS-2 (trade name, manufactured by ORGANO CORPORATION): gel-type strongly basic anion exchange resin, resin material: styrene-divinylbenzene copolymer, type of ion exchange group: quaternary ammonium group
ORLITE (registered trademark) DS-21 (trade name, manufactured by ORGANO CORPORATION): macroporous-type weakly acidic chelating resin, resin material: styrene-divinylbenzene copolymer, type of ion exchange group: aminophosphate group.

### Reference Example 1: Comparison of the Amount of Solvent Replacement by Type of Ion Exchange Resin

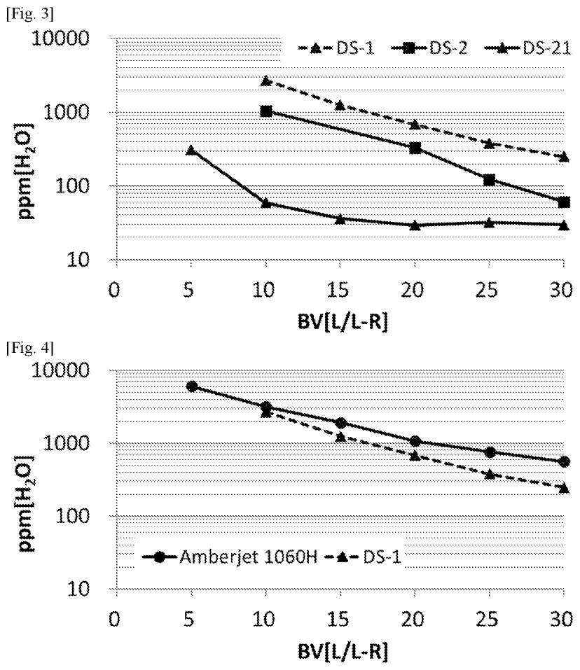

A PFA column (inner diameter: 16 mm, height: 300 mm) was filled with 50 ml of each of DS-2, DS-1, and DS-21 ion exchange resins in a water-wetted state, and IPA (trade name: TOKUSOH IPA (registered trademark) SE grade, manufactured by Tokuyama Corporation) with a water concentration of 30 ppm was supplied at SV=5 h⁻¹ and continued to be supplied until the BV reached 30. The water concentration in IPA at the column outlet in each BV was analyzed to confirm the effect of solvent replacement. Results are shown in Table 1 and FIG. 3. Note that the ion exchange resin in a water-wetted state is obtained by bringing the ion exchange resin into contact with an atmosphere of 100% relative humidity at 25° C. for at least 30 minutes.

As shown in Table 1 and FIG. 3, DS-2, a strongly basic anion exchange resin, had a water concentration of about 60 ppm at 30 BV, and DS-1, a strongly acidic cation exchange resin, had a water concentration of 250 ppm at 30 BV and neither of these water concentrations was reduced to a level equivalent to the original liquid. On the other hand, DS-21, a chelating resin with a weakly acidic cationic group, reduced the water concentration to a level equivalent to that of the original liquid at 15 BV. These results suggest that in strongly acidic cation exchange resins and strongly basic anion exchange resins, water molecules are hydrated with strongly acidic cation exchange groups or strongly basic anion exchange groups, making it difficult for solvent replacement to occur.

TABLE 1

| | water concentration (ppm) | | |
|---|---|---|---|
| BV | DS-2 | DS-1 | DS-21 |
| 5 | — | — | 310 |
| 10 | 1037 | 2690 | 59 |
| 15 | — | 1247 | 36 |
| 20 | 332 | 685 | 29 |
| 25 | 123 | 379 | 32 |
| 30 | 61 | 250 | 30 |

### Reference Example 2: Comparison of the Amount of Solvent Replacement by Strongly Acidic Cation Exchange Resins with Different Degrees of Cross-Linking

A PFA column (inner diameter: 16 mm, height: 300 mm) was filled with 50 ml of each of AMBERJET 1060H (degree of cross-linking: 16%) and DS-1 (with general degree of cross-linking) ion exchange resins in a water-wetted state, and IPA (trade name: TOKUSOH IPA (registered trademark) SE grade, manufactured by Tokuyama Corporation) with a water concentration of 30 ppm was supplied at SV=5 h⁻¹ and continued to be supplied until the BV reached 30. The water concentration in IPA at the column outlet in each BV was analyzed to confirm the effect of solvent replacement. Results are shown in Table 2 and FIG. 4.

TABLE 2

water concentration (ppm)

| BV | 1060H | DS-1 |
|---|---|---|
| 5 | 6084 | — |
| 10 | 3194 | 2690 |
| 15 | 1924 | 1247 |
| 20 | 1073 | 685 |
| 25 | 763 | 379 |
| 30 | 563 | 250 |

As shown in Table 2, AMBERJET 1060H, a highly cross-linked gel-type strongly acidic cation exchange resin, had a water concentration of 563 ppm at 30 BV, even higher than DS-1 having a general degree of cross-linking that is not highly cross-linked. Highly cross-linked gel-type strongly acidic cation exchange resins are thought to be even more resistant to solvent replacement than strongly acidic cation exchange resins with a general degree of cross-linking, because the pores are small, and in addition to the effects of hydration, the replacement of water with solvent is difficult to occur.

### Reference Example 3: Concentration of Metals to be Reduced in Methanol for Pretreatment

The concentrations of five elements that are metals to be reduced in methanol (EL grade, manufactured by FUJIFILM Wako Pure Chemical Corporation) used as a nonaqueous liquid for pretreatment were measured. As shown in Table 3, the concentration of metals to be reduced was 1 μg/L or less.

TABLE 3

| metals to be | metal concentration |
|---|---|
| reduced | (μg/L) |
| Na | 0.2 |
| K | <0.1 |
| Ca | 0.6 |
| Fe | <0.1 |
| Al | <0.1 |
| total | 1 or less |

### Comparative Example 1: PGMEA Replacement Using Highly Cross-Linked Strongly Acidic Cation Exchange Resin

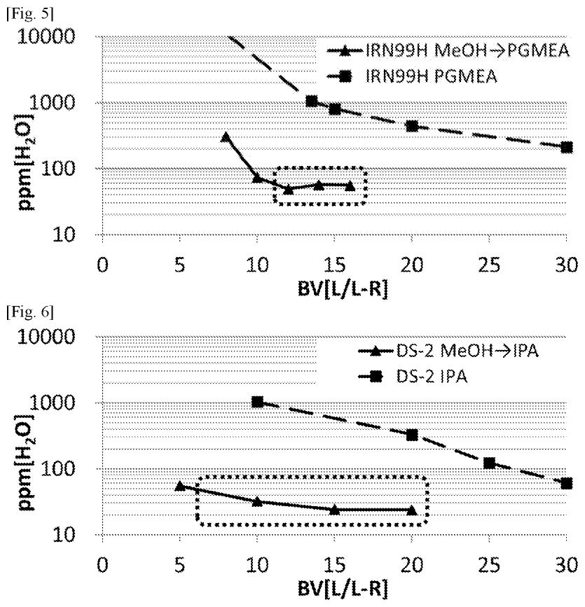

A PFA column (inner diameter: 16 mm, height: 300 mm) was filled with 50 ml of IRN99H in a water-wetted state, and the hydrolyzable solvent, PGMEA (trade name: PM Thinner, manufactured by TOKYO OHKA KOGYO CO., LTD.) with a water concentration of 45 ppm and a concentration of metals to be reduced of 1 μg/L or less, was supplied at SV=5 h⁻¹. The feed was continued until the BV reached 30, and the water concentration in PGMEA at the column outlet at each BV was analyzed to confirm the effect of solvent replacement. Results are shown in Table 4 and FIG. 5. As shown in Table 4, the water concentration at 20 BV was about 450 ppm when the solvent was replaced using only PGMEA without a pretreatment step.

TABLE 4

| BV | water concentration (ppm) |
|---|---|
| 8 | 10888 |
| 14 | 1056 |
| 15 | 803 |
| 20 | 446 |
| 30 | 216 |

### Example 1: Methanol-PGMEA Replacement Using Highly Cross-Linked Strongly Acidic Cation Exchange Resin

A PFA column (inner diameter: 16 mm, height: 300 mm) was filled with 50 ml of IRN99H in a water-wetted state. Next, methanol (EL grade, manufactured by FUJIFILM Wako Pure Chemical Corporation) with a water concentration of 33 ppm and a concentration of metals to be reduced of 1 μg/L or less, as described in Reference Example 3, was supplied at SV=5 h⁻¹ as a nonaqueous liquid for pretreatment. The methanol feed was continued until the BV reached 12 and the water concentration in methanol at the column outlet at each BV was analyzed. Then, PGMEA (trade name: PM Thinner, manufactured by TOKYO OHKA KOGYO CO., LTD.) with a water concentration of 45 ppm and a concentration of metals to be reduced of 1 μg/L or less was supplied from 12 BV to 16 BV of total nonaqueous liquid volume (total volume of methanol and PGMEA) (the range enclosed by the dotted line in the graph shown in FIG. 5), and the water concentration in PGMEA at the column outlet at each BV was analyzed. Results are shown in Table 5 and FIG. 5.

TABLE 5

| | BV | | water |
|---|---|---|---|
| nonaqueous | each | total | concentration |
| liquid | nonaqueous liquid | nonaqueous liquid | (ppm) |
| MeOH | 8 | 8 | 308 |
| | 10 | 10 | 73 |
| | 12 | 12 | 49 |
| PGMEA | 2 | 14 | 57 |
| | 4 | 16 | 56 |

As shown in Table 5 and FIG. 5, in Example 1, the water concentration was already reduced to a level equivalent to that of PGMEA to be purified when 12 BV of methanol was passed as the nonaqueous liquid for pretreatment. PGMEA was then passed through to replace the methanol inside the resin with PGMEA to be purified. The flow volume of PGMEA was 4 BV, but the methanol was considered to have been almost completely removed when 3 BV of PGMEA was passed, so the total flow volume of the nonaqueous liquid required was considered to be 15 BV. Thus, in Example 1, water inside the resin could be replaced with a nonaqueous liquid with an apparently smaller amount of nonaqueous liquid than in Comparative Example 1.

In this example, methanol was replaced with PGMEA by passing 3 BV of PGMEA as described above. Since PGMEA and methanol mix readily, it is likely that most of the methanol is pushed out and removed by the solvent replacement by PGMEA. However, if a small amount of the remaining methanol is problematic as an impurity, the methanol concentration in PGMEA should be analyzed as appropriate, and PGMEA should be passed through until the methanol concentration is reduced below the target concentration.

### Comparative Example 2: IPA Replacement Using Strongly Basic Anion Exchange Resin

A PFA column (inner diameter: 16 mm, height: 300 mm) was filled with 50 ml of DS-2 in a water-wet state. Next, IPA (trade name: TOKUSOH IPA (registered trademark) SE grade, manufactured by Tokuyama Corporation) with a water concentration of 18 ppm and a concentration of metals to be reduced of 1 μg/L or less was supplied at SV=5 h⁻¹. The feed was continued until the BV reached 30, and the water concentration in IPA at the column outlet at each BV was analyzed. Results are shown in Table 6 and FIG. 6. As shown in Table 6, the water concentration in IPA at the column outlet after 30 BV flow was about 60 ppm.

TABLE 6

| BV | water concentration (ppm) |
|---|---|
| 10 | 1037 |
| 20 | 332 |
| 25 | 123 |
| 30 | 61 |

### Example 2: Methanol-IPA Replacement Using Strongly Basic Anion Exchange Resin

A PFA column (inner diameter: 16 mm, height: 300 mm) was filled with 50 ml of DS-2 in a water-wetted state. Next, methanol (EL grade, manufactured by FUJIFILM Wako Pure Chemical Corporation) with a water concentration of 31 ppm and a concentration of metals to be reduced of 1 μg/L or less, as described in Reference Example 3, was supplied at SV=5 h⁻¹ as a nonaqueous liquid for pretreatment. The methanol feed was continued until the BV reached 5, and the water concentration in methanol at the column outlet was analyzed. Next, IPA (trade name: TOKUSOH IPA (registered trademark) SE grade, manufactured by Tokuyama Corporation) with a water concentration of 21 ppm and a concentration of metals to be reduced of 1 μg/L or less was supplied until the total nonaqueous liquid volume (total volume of methanol and IPA) reached 20 BV (the range enclosed by the dotted line in the graph shown in FIG. 6). The water concentration in IPA at the column outlet at each BV was analyzed. Results are shown in Table 7 and FIG. 6.

TABLE 7

| | BV | | water |
|---|---|---|---|
| nonaqueous | each | total | concentration |
| liquid | nonaqueous liquid | nonaqueous liquid | (ppm) |
| MeOH | 5 | 5 | 55 |
| IPA | 5 | 10 | 32 |
| | 10 | 15 | 24 |
| | 15 | 20 | 24 |

As shown in Table 7, in Example 2, the water concentration at the column outlet was reduced to a level equivalent to the IPA used at about 15 BV of total nonaqueous liquid. Thus, by passing methanol as a pretreatment step, the water inside the resin could be replaced with a nonaqueous liquid with an apparently smaller amount of nonaqueous liquid than in Comparative Example 2.

### Comparative Example 3: Generation of Acetic Acid

A PFA column (inner diameter: 16 mm, height: 300 mm) filled with 36 mL of AMBERJET 1060H, a highly cross-linked gel-type strongly acidic cation exchange resin, was passed 20 BV of PGMEA using the same procedure as in Comparative Example 1. The water concentration in PGMEA at the column outlet at the time of 20 BV flow-through was measured to be 1005 ppm. The treated liquid after the passage was stored overnight, and the acetic acid concentration of the supernatant liquid was analyzed. As shown in Table 8, the concentration of acetic acid in the supernatant liquid was higher than that of the original liquid, confirming the formation of acetic acid through hydrolysis.

### Example 3: Generation of Acetic Acid

A PFA column (inner diameter: 16 mm, height: 300 mm) filled with 36 mL of AMBERJET 1060H, a highly cross-linked gel-type strongly acidic cation exchange resin, was passed 20 BV (total nonaqueous volume) of methanol (concentration of metals to be reduced: 1 μg/L or less) and PGMEA (concentration of metals to be reduced: 1 μg/L or less) using the same procedure as in Example 1 (but with an additional 4 BV of PGMEA flow-through). The water concentration in PGMEA at the column outlet at the time of passing 20 BV of total nonaqueous liquid was 58 ppm, a level comparable to PGMEA used. The treated liquid after the passage was stored overnight, and the acetic acid concentration of the supernatant liquid was analyzed. As shown in Table 8, the concentration of acetic acid in the supernatant liquid was at the same level as the original liquid, confirming that little acetic acid is generated after solvent replacement.

TABLE 8

| | |
|---|---|
| Comparative Example 3 | Example 3 |
| AMBERJET 1060H | AMBERJET 1060H |
| (without MeOH pretreatment) | (with MeOH pretreatment) |

| flow volume | acetic acid | flow volume | acetic acid |
|---|---|---|---|
| (BV) | (ppm) | (BV) | (ppm) |
| 0 (original liquid) | 15 | 0 (original liquid) | 15 |
| 20 | 72 | 20 | 14 |

| | |
|---|---|
| acetic acid increase: YES | acetic acid increase: NO |

Highly cross-linked gel-type strongly acidic cation exchange resins have smaller pores than MR-type resins, even though they are also highly cross-linked, and PGMEA is less likely to move in and out from the resin surface to the interior. Therefore, acetic acid generation by hydrolysis of PGMEA is considered less likely to occur than with gel-type resins that are not highly cross-linked, or MR-type, porous-type, or highly-porous-type resins.

As mentioned above, highly cross-linked gel-type strongly acidic cation exchange resins were difficult to replace with solvents. However, pretreatment using the nonaqueous liquid for pretreatment according to the present invention enabled replacement of water with nonaqueous liquid in a small amount of nonaqueous liquid, and furthermore, purification with suppressed hydrolysis of PGMEA.

### EXPLANATIONS OF LETTERS OR NUMERALS

1: Ion exchange resin column
2: Storage tank (nonaqueous liquid for pretreatment)
3: Storage tank (waste liquid)
4: Storage tank (nonaqueous liquid to be purified before purification)
5: Storage tank (nonaqueous liquid to be purified after purification)
6: Eye plate and mesh
7: Ultrapure water line
8: Conductivity meter or resistivity meter
P: Pump
11: Ion exchange resin column
12: Storage tank (nonaqueous liquid for pretreatment)
13: Storage tank (liquid waste)
14: Eye plate and mesh
15: Ultrapure water line
16: Conductivity meter or resistivity meter
17: Ion exchange resin column
18: Storage tank (nonaqueous liquid to be purified before purification)
19: Storage tank (waste liquid)
20: Storage tank (nonaqueous liquid to be purified after purification)
21: Eye plate and mesh
22: Ultrapure water line
23: Conductivity meter or resistivity meter

1. A method for purifying a nonaqueous liquid using an ion exchange resin, the method comprising:
bringing the ion exchange resin into contact with a nonaqueous liquid for pretreatment having a relative permittivity at 25° C. of 20 or higher; and
bringing the ion exchange resin after the pretreatment into contact with a nonaqueous liquid to be purified,
wherein the relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

2. The method for purifying the nonaqueous liquid according to claim 1, wherein the nonaqueous liquid for pretreatment is methanol having a water concentration of 100 ppm or less.

3. The method for purifying the nonaqueous liquid according to claim 1, wherein the ion exchange resin comprises at least a cation exchange resin.

4. The method for purifying the nonaqueous liquid according to claim 3, wherein the cation exchange resin is a gel-type strongly acidic cation exchange resin having a degree of cross-linking of 16% to 24%.

5. The method for purifying the nonaqueous liquid according to claim 1, wherein the nonaqueous liquid to be purified is selected from PGME, PGMEA, a mixture of PGME and PGMEA, and IPA.

6. An apparatus for purifying a nonaqueous liquid using an ion exchange resin, the apparatus comprising:
a pretreatment device provided with pretreatment means for bringing the ion exchange resin into contact with a nonaqueous liquid for pretreatment having a relative permittivity at 25° ° C. of 20 or higher; and
a purification device provided with purification means for bringing the ion exchange resin, which has been brought into contact with the nonaqueous liquid for pretreatment, into contact with a nonaqueous liquid to be purified;
wherein the relative permittivity at 25° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.

7. The apparatus for purifying the nonaqueous liquid according to claim 6, wherein the nonaqueous liquid for pretreatment is methanol having a water concentration of 100 ppm or less.

8. The apparatus for purifying the nonaqueous liquid according to claim 6, wherein the ion exchange resin comprises at least a cation exchange resin.

9. A pretreatment device for an ion exchange resin used for purification of a nonaqueous liquid, the device comprising:
pretreatment means for bringing the ion exchange resin into contact with a nonaqueous liquid for pretreatment having a relative permittivity at 25° C. of 20 or higher,
wherein the nonaqueous liquid for pretreatment is passed through the ion exchange resin at 1 BV or higher in the pretreatment means.

10. A method for producing an ion exchange resin used for purification of a nonaqueous liquid, the method comprising:
bringing the ion exchange resin into contact with a nonaqueous liquid for pretreatment having a relative permittivity at 25° ° C. of 20 or higher,
wherein the relative permittivity at 25° ° C. of the nonaqueous liquid for pretreatment is greater than the relative permittivity at 25° C. of the nonaqueous liquid to be purified, and the concentration of metals to be reduced in the nonaqueous liquid for pretreatment is 5 μg/L or less.
